(19) United States
(12) Patent Application Publication
(10) Pub. No.: US 2017/0193580 A1
(43) Pub. Date: Jul. 6, 2017

(54) SYSTEM AND METHOD FOR MATCHING ANIMAL CARE PROVIDERS WITH ANIMAL OWNERS

(71) Applicant: PETMEDICUS HOLDINGS LLC, Buffalo, NY (US)

(72) Inventors: CHRISTOPHER E. TURNER, Arvada, CO (US); BENJAMIN M. MAHFOOD, Tyler, TX (US)

(21) Appl. No.: 14/983,900

(22) Filed: Dec. 30, 2015

(51) Int. Cl. G06Q 30/06

(52) U.S. Cl. CPC G06Q 30/0627

(57) ABSTRACT

Provided is a system and method for matching Animal Care Providers with animal owners based on a plurality of factors with a weighting component. In general, the systems and methods commence with establishing a database of Animal Care Providers from public information specifying for each Animal Care Provider a plurality of Practice Factors, including at least a name, state license, address and animal practice. The systems and methods next receive from at least a subset of Animal Care Providers additional Practice Factors correlated to the to the providing Animal Care Provider, the additional Practice Factors selected from a group consisting of: years in practice, animal specialty, procedure specialty, veterinarian age, veterinarian gender, animal type, category of services offered, insurance accepted. The matching is performed when a query from an Animal Owner seeking an Animal Care Provider is received, the query including a plurality of Desired Factors. At least one weighting factor is applied to at least one Desired Factor and the Desired Factors are evaluated to the Practice Factors of each Animal Care Provider in the database to identify at least a subset of Animal Care Providers matching on at least a pre-determined number of factors including the weighted Desired Factor. The resulting subset of matching Animal Care Providers is then returned to the querying Animal Owner.

### FIELD OF THE INVENTION

The present invention relates generally to systems and methods for companion animal owners to find animal care providers, and more specifically, to an online system and method for companion pet owners to find animal care providers who have a plurality of desired characteristics, such as but not limited to animal species, procedures, clinical specialties, education—characteristics beyond mere proximity and hours.

### BACKGROUND

Companion animals a.k.a. pets are an integral part of American life.

According to the biennial APPA National Pet Owners Survey from 2015-16, there are 79.7 million American households with pets. That represents 65% of the American households. Furthermore, 42% of those households have more than one pet. The estimated number of dogs and cats in American households is 163.6 million. This does not include the number of many other companion animals living with Americans, including birds, a variety of reptiles, pigs, small livestock and many others. There is one commonality with all companion animals—the reliance on their owners for care and comfort.

Just as companion animals rely on their owners for care and comfort, pet and livestock owners rely on the training, expertise and skills of a veterinarian and/or animal clinic experts to provide essential medical care for their pet. Medical care includes successful treatment of diagnosed ailment; prescription medication to aid in healing and preventative measures to ensure the medical condition, either acute or chronic is cured or properly managed.

Moreover, while a person may actively participate with his or her own medical care—describing what he or she feels, or perhaps relaying for a relative what they have described, the pet owner is truly reliant upon the training and experience of the animal care provider to not only treat his or her pet, but also to perceive what may or may not be of issue and or be able to prescribe treatments to avoid possible ailments as the pet does not talk.

Currently, the American Kennel Club (AKC) recognizes 184 dog breeds, with new breeds being recognized every year. The Cat Fanciers' Association (CFA) currently recognizes 41 pedigreed cat breeds. This is a remarkable number of breeds currently recognized and does not include the number of pet owners that do not have pure breed animals. Many American households have mixed breed animals; in fact, the APPA survey showed that 37% of dogs and 46% of cats in American households are adopted through the thousands of shelters across the country. All of them with different medical needs. These medical needs become even more diverse with the significant number of other animals kept as pets in the U.S.

Perhaps once seen as a friendly companion who kept pests at bay, modern pets are often very doted upon with special foods, toys, treats, drinks, beds, and even clothing. When a pet is sick or injured a mere animal generalist may be ok, but a person trained and experienced with the breed or species may be most highly desired and sought after.

And while people can and do share recommendations with one another for professional services, often again the differences in preferred breeds and species make recommendations for animal care specialists more challenging on a person to person basis.

Online search engines have grown in popularity, but the typical search engine directive is proximity. Proximity is very often not the most significant factor in identifying a desired animal care provider. An owner seeking care for a Macaw Parrot, Pot Belly Pig, or Bull Dog with respiratory issues is not aided by a search engine returning a plurality of Animal Care providers ranked strictly by distance. Further still, even a directed query run through a general search engine may or may not return proper, helpful or even complete results.

Moreover, even though there are a growing number of options that permit a person to search for his or her own medical needs, a similar extension for animal care providers is non-existent.

Hence there is a need for a method and system that is capable of overcoming one or more of the above identified challenges.

### SUMMARY OF THE INVENTION

Our invention solves the problems of the prior art by providing novel systems and methods for matching Animal Care Providers with Animal Owners based on a plurality of Factors with a weighting component.

In particular, and by way of example only, according to one embodiment of the present invention, provided is a method of matching Animal Care Providers with animal owners based on a plurality of factors with a weighting component, including: establishing a database record of Animal Care Providers from public information specifying for each Animal Care Provider a plurality of Practice Factors including at least a name, state license, address, and animal practice; receiving from at least a subset of Animal Care Providers additional Practice Factors correlated to the providing Animal Care Provider, the additional Practice Factors selected from a group consisting of: years in practice, animal specialty, procedure specialty, veterinarian age, veterinarian gender, animal type, category of services offered, insurance accepted; receiving a query from a animal owner seeking an Animal Care Provider, the query including a plurality of Desired Factors; applying at least one weighting factor to at least one Desired Factor and evaluating the Desired Factors to the Practice Factors of each Animal Care Provider in the database record to identify at least a subset of Animal Care Providers matching at least a pre-determined number of factors including the weighted Desired Factor; and returning to the querying animal owner the subset of matching Animal Care Providers.

For another embodiment, provided is a method of matching Animal Care Providers with animal owners based on a plurality of factors with a weighting component, including: a database system having a processor and a database, the database having a plurality of records for Animal Care Providers with a plurality of Practice Factors including at least a name, state license, address, and animal practice for each Animal Care Provider; an I/O system having at least one processor and being in communication with the database system, the I/O system structured and arranged to receive from at least a subset of Animal Care Providers additional Practice Factors selected from a group consisting of: years in practice, animal specialty, procedure specialty, veterinarian age, veterinarian gender, animal type, category of services offered, insurance accepted; the I/O system further structured and arranged to receive a query from a animal owner seeking a Animal Care Provider, the query including a plurality of Desired Factors; and an evaluation system having at least one processor and being in communication with the database system and the I/O system, the evaluation system structured and arranged to receive the query from the I/O system and apply at least one weighting factor to at least one Desired Factor, the evaluation system evaluating the Desired Factors to the Practice Factors of each Animal Care Provider in the database to identify at least a subset of Animal Care Providers matching a pre-determined number of factors including the weighted Desired Factor, and returning the subset of matching Animal Care Providers to the I/O system for delivery to the querying animal owner.

Further, in yet another embodiment provided is a non-transitory machine readable medium on which is stored a computer program comprising instructions to adapt a computer system having at least one processor to match Animal Care Providers with animal owners based on a plurality of factors with a weighting component including: an I/O module operatively associated with an input device and a database, the database having a plurality of records for Animal Care Providers with a plurality of Practice Factors including at least a name, state license, address, and animal practice for each Animal Care Provider, the I/O module further structured and arranged to receive a query from an animal owner seeking a Animal Care Provider, the query including a plurality of Desired Factors; and an evaluation module for evaluating the query and applying at least one weighting factor to at least one Desired Factor, the evaluation module evaluating the Desired Factors to the Practice Factors of each Animal Care Provider in the database to identify at least a subset of Animal Care Providers matching a pre-determined number of Practice Factors including the weighted Desired Factor, and returning the subset of matching Animal Care Providers to the I/O module for delivery to the querying animal owner.

### BRIEF DESCRIPTION OF THE DRAWINGS AND SUPPORTING MATERIALS

FIG. 1 illustrates a high level diagram of a system for matching Animal Care Providers with Animal Owners based on a plurality of Factors with a weighting component in accordance with at least one embodiment;

FIG. 2 illustrates a table of a Animal Care Providers and specifically their associated Practice Factors in accordance with at least one embodiment;

FIG. 3 is a flow diagram of at least one method for matching Animal Care Providers with Animal Owners based on a plurality of Factors with a weighting component in accordance with at least one embodiment;

FIGS. 4-11 are conceptual illustrations of the Owner's interface as may be provided to an Owner to indicate a plurality of Desired Factors for evaluation to Practice Factors of Animal Care Providers and the resulting matched list of Animal Care Providers in accordance with at least one embodiment; and

FIG. 12 is a high level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for matching animal care providers with animal owners based on a plurality of factors with a weighting component. Thus although the instrumentalities described herein are for the convenience of explanation shown and described with respect to exemplary embodiments, it will be understood and appreciated that the principles herein may be applied equally in other types of systems and methods involving matching animal care providers with animal owners.

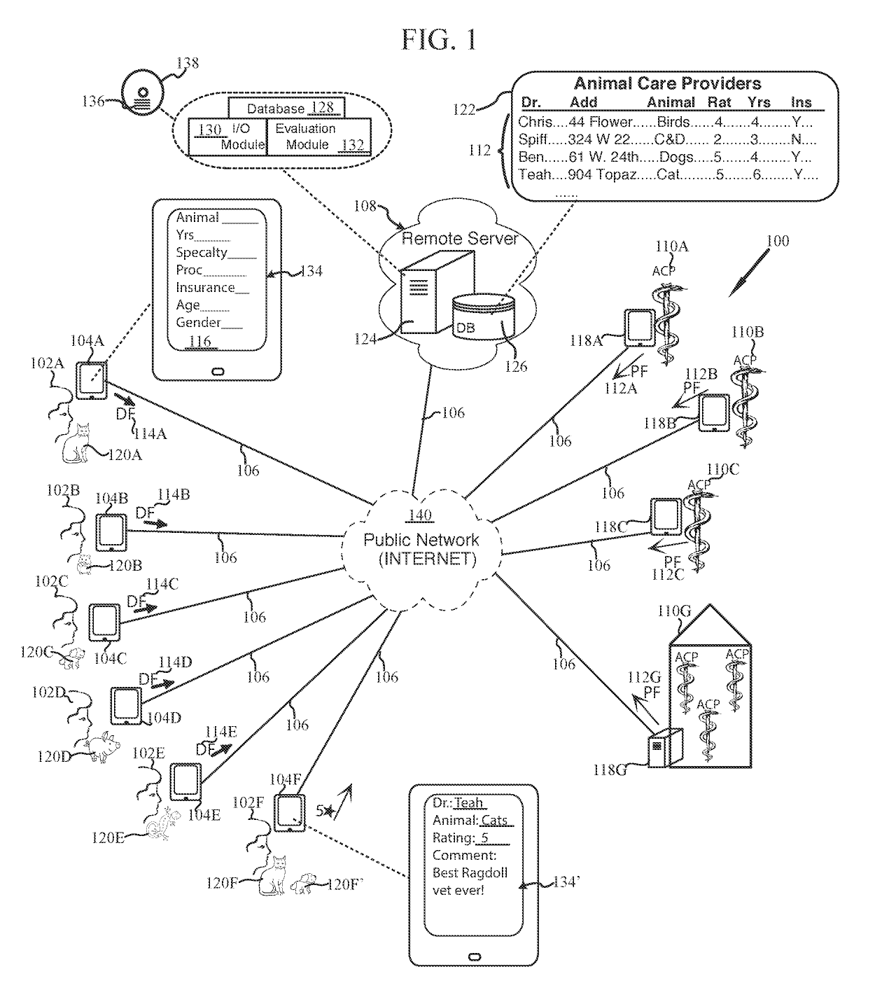

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

Various embodiments presented herein are descriptive of apparatus, systems, articles of manufacturer, or the like for systems and methods involving matching animal care providers with animal owners based on a plurality of factors with a weighting component. In some embodiments, an interface, application browser, window or the like may be provided that allows the user of the computing device to direct behavior of the computing device.

Moreover, some portions of the detailed description that follow are presented in terms of the manipulation and processing of data bits within a computer memory. The steps involved with such manipulation are those requiring the manipulation of physical quantities. Generally, though not necessarily, these quantities take the form of electrical or magnetic signals capable of being stored, transferred, combined, compared and otherwise manipulated. Those skilled in the art will appreciate that these signals are commonly referred to as bits, values, element numbers or other clearly identifiable components.

It is of course understood and appreciated that all of these terms are associated with appropriate physical quantities and are merely convenient labels applied to these physical quantifies. Moreover, it is appreciated that throughout the following description, the use of terms such as “processing” or “evaluating” or “receiving” or “outputting” or the like, refer to the action and processor of a computer system or similar electronic computing device that manipulates and transforms data represented as physical (electrical) quantities within the computer system's memories into other data similarly represented as physical quantities within the computer system's memories.

The present invention also relates to apparatus for performing the operations herein described. This apparatus may be specifically constructed for the required purposes as are further described below, or the apparatus may be a general purpose computer selectively adapted or reconfigured by one or more computer programs stored in the computer upon computer readable storage medium suitable for storing electronic instructions.

To further assist in the following description, the following defined terms are provided.

“Animal”—a non-human living creature such as, but not limited to a dog, cat, reptile, fish, bird, equine, swine, or the like as may be kept or owned as a pet or live stock. Although the systems and methods for matching animal care providers to animal owners are intended in most cases for use with pets, application to breeding stock or livestock such as may be used to provide pets, or even livestock is understood and appreciated to be within the scope of this application.

“Animal Care Provider/ACP”—the veterinarian, animal care giver or other licensed practitioner who is trained in and actively licensed at a State or Federal level to provide medical care for Animals. Typically this person may be understood and appreciated to be a Veterinarian or Veterinary Physician as a professional who is trained to treat disease, disorder and injury to non-human animals. An Animal Care Provider may also be a clinic or other business entity that operates to provide such non-human animal care by employing one or more Veterinary Physicians.

“Owner”—or Animal Owner, or Pet Owner is the person seeking care or treatment for his or her Animal. It is specifically understood and appreciated that the Owner is not seeking medical care or assistance for himself or another human being, but an Animal.

“Practice Factors”—elements that may be correlated to one or more Animal Care Providers, such as but not limited to: years in practice, animal specialty, procedure specialty, veterinarian age, veterinarian gender, animal type, care philosophy, procedures specialty, procedure sub-specialty, clinic affiliation, prices for procedures, address, phone number, education and training (undergraduate, graduate, post graduate school), certification(s), license(s), interests, awards, honors, interests/hobbies, recognitions, clinical specialties, faculty appointments, work history, clinical trials, publications, insurance, presentations, grants, research, committees, professional memberships, languages, former/prior affiliations, medical group, medical practice, industry partnerships, social media accounts, sanctions, malpractice, customer/animal owner satisfaction. These elements may be absolute qualities—i.e., years in practice 6, gender is female—or relative, provider is a marathoner and likes classical music.

“Desired Factor”—elements that are desired by the Owner as he or she seeks to identify and or select an Animal Care Provider for his or her pet(s).

“Weighting Factor”—is at least one element that may be used to weight the correlation of Desired Factors to Practice Factors, and a Weighting Factor may indeed be a Practice Factor such as, but not limited to customer/animal owner satisfaction.

“Database System, I/O System, Evaluation System, First System”—The computing system to which Owners and/or Animal Care Providers connect when establishing their initial accounts or querying for Animal Care Providers. In varying embodiments Database System also permits Owners and Animal Care Providers to maintain accounts, update Practice Factors, compare Desired Factors to Practice Factors, and maintain history.

“Database”—the collection of related data and the way it is organized. Moreover, although a Database System is a physical system, the Database itself is understood to be the collection of tables, reports, schemas, or other organizational forms of the recorded data that may be updated, replaced, deleted, and manipulated as elements to provide new elements. When referring an action of “retrieving from the database” or “establishing a database” although the physical machine may indeed be accessed, it is generally understood and appreciated to be an element of data that is being transferred. When reference to the physical system is intended, herein reference shall be made to the database system. When referring simply to the database, a record, or the database record herein, it should be understood and appreciated as referring to the database as the organization of collected data.

With respect to the above defined terms, it is understood and appreciated that for at least one embodiment, each module or system is implemented as a collection of independent electronic circuits packaged as a unit upon a printed circuit board or as a chip attached to a circuit board or other element of a computer so as to provide a basic function within a computer. In varying embodiments, one or more modules may also be implemented as software that adapts a computer to perform a specific task or basic function as part of a greater whole. Further still, in yet other embodiments one or more modules may be provided by a mix of both software and independent electronic circuits.

To briefly summarize, provided is a system and method for matching Animal Care Providers with animal owners based on a plurality of factors with a weighting component. In general, the systems and methods commence with establishing a database of Animal Care Providers from public information specifying for each Animal Care Provider a plurality of Practice Factors, including at least a name, state license, address and animal practice.

To augment these initial Practice Factors, the systems and methods next receive from at least a subset of Animal Care Providers additional Practice Factors correlated to the to the providing Animal Care Provider, the additional Practice Factors selected from a group consisting of: years in practice, animal specialty, procedure specialty, veterinarian age, veterinarian gender, animal type, category of services offered, insurance accepted. The matching is performed when a query from an Animal Owner seeking an Animal Care Provider is received, the query including a plurality of Desired Factors.

At least one weighting factor is applied to at least one Desired Factor and the Desired Factors are evaluated to the Practice Factors of each Animal Care Provider in the database to identify at least a subset of Animal Care Providers matching on at least a pre-determined number of factors including the weighted Desired Factor. The resulting subset of matching Animal Care Providers is then returned to the querying Animal Owner.

This summary may be more fully appreciated with the respect to the following description and accompanying figures.

Turning now to the drawings, and more specifically, FIG. 1, there is shown a high level diagram of an embodiment of a system for matching Animal Care Providers with Animal Owners, e.g., MACP 100.

Moreover, MACP 100 permits Owners 102 with a First User Device 104 with communication links 106 providing network access a remote server 108 and query for at least one Animal Care Provider 110 who's Practice Factors 112 correlate to at least some of the Desired Factors 114.

With respect to FIG. 1, for the present example, there are shown a plurality of Owners, of which Owners 102A, 102B, 102C, 102D, 102E and 102F are exemplary. Each Owner 102A-102F has a corresponding Owner Device, hereinafter “OD” or First Device 104A-104F, each of which is understood and appreciated to be a computing device having at least one processor. Further, each first device 104 has a visual display screen 116.

In addition to the plurality of Owners 102, FIG. 1 also shows a plurality of Animal Care Providers 110, of which Animal Care Providers 110A, 110B, 110C and 110G are exemplary. Each Animal Care Provider 110 also has a corresponding computing device, or Second Device 118A-118D understood and appreciated to be a computing device having at least one processor, computing devices 118A-118C shown to be smart phones, and computing device 118G shown to be a computer work station.

Moreover, each First Device 104 has been illustrated as a wireless smart phone, and but may alternatively comprise either a desktop computer system, portable computer or data assistant that is capable of network access by way of a fixed network cable or wireless communication using WiFi networks, wireless network access points, cellular networks, and or other such technologies. Moreover, for at least one embodiment, the Owner devices 104A-104H are smart phone devices such as, but not limited to the Apple Computers iPhone® or Samsung Android® device. The same is true for Second Devices 118A-118C, with Second Device 118G simply shown as a computing work station for breadth of disclosure.

As is also shown, each Owner 102A-102F has at least one Animal 120A-120F′, and as shown by the visual representations, there is a wide variety of Animals 120, including cats 120A & 120F, dogs 120C & 120F′, a hamster 120D, a pig 120D, and a lizard 120E. And of course it is understood and appreciated that there are likely different breeds of Animals so that even within a general category—i.e., dog or cat, there are likely a plethora of different breeds with potentially different medical concerns and treatments.

As is also shown in FIG. 1, remote server 108 has a database record 122 (hereinafter database 122) of the Practice Factors 112 for each Animal Care Provider 110 known within MACP 100. In varying embodiments, the database 122 may be a component integrated with the remote server 108, or a remote database to which the remote server 108 has access right when and as needed. For the present example as shown, the database 122 is shown as a component of the remote server 108.

For at least one embodiment, the remote server 108 is understood and appreciated to be a computing device including at least one microprocessor, memory and the like which are adapted by hardware or software to permit data exchange over a network. In addition for at least one embodiment, the remote server 108 has a physical computer system 124 (including at least one microprocessor, memory, I/O device(s) and the like) including a database system 126 for maintaining the database 122 of Practice Factors 112 and is at least in part adapted to provide remote server 108 in part by a database module 128, an I/O module 130 and an evaluation module 132.

The I/O module 130 is operatively associated with an input output device and the database 122 so as to receive additional Practice Factors 112 from at least the Animal Care Providers 110 and queries with Desired Factors from Owners 102. The Evaluator module 132 is operable to evaluate the query and apply at least one weighting factor to a least one Desired Factor. Moreover the evaluator module 132 evaluates the Desired Factors to the Practice Factors 112 in the database 122 to identify at least a subset of Animal Care Providers 110 matching on a pre-determined number of Practice Factors including the weighted Desired Factor. Of course for an alternative embodiment, the evaluator module 132 may evaluate the Practice Factors 112 in the database 122 to the Desired Factors to identify at least a subset of Animal Care Providers 110 matching on a pre-determined number of Practice Factors including the weighted Desired Factor. By either option, the demined subset of matched Animal Care Providers 110 is returned to the I/O module 130 for delivery to the querying Owner 102.

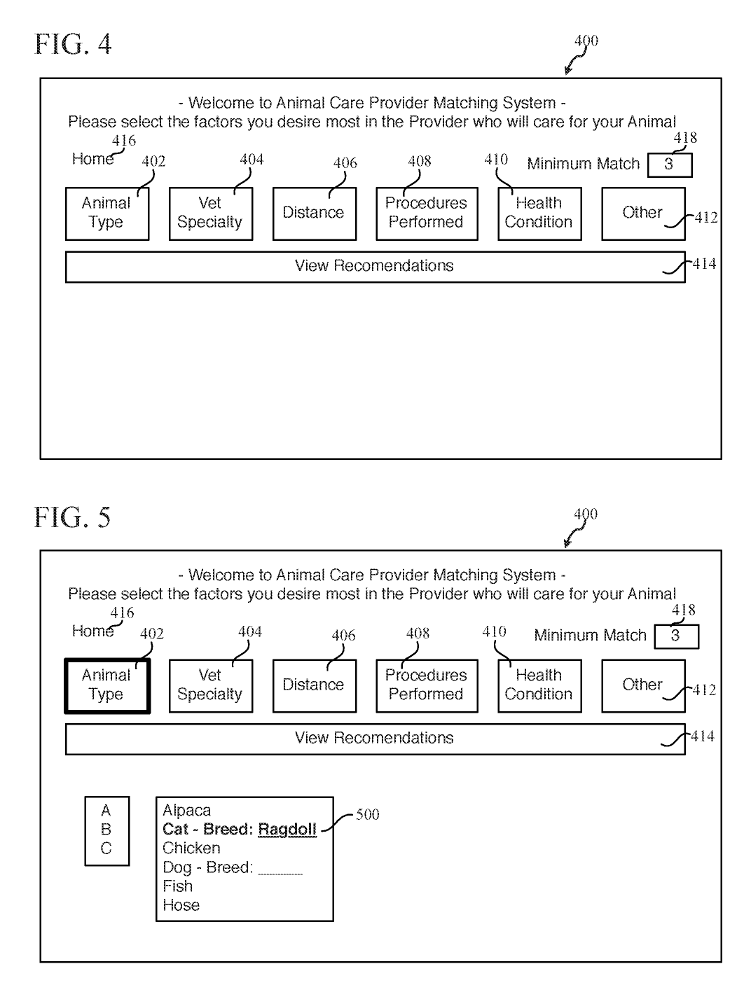

For at least one embodiment, the I/O module 130 provides a web page interface 134 for Owners to submit their Queries. FIGS. 4-11 below and their associated description will further describe at least one exemplary embodiment for the web page interface 134.

In addition, web page interface 134 also permits Owners 102 to provide owner ratings as Practice Factors 112 for Animal Care Providers 110. More specifically, owner 102F has web page interface 134′ shown on her first device 104F—shown in enlarged detail. Owner 102F is using web page interface 134′ to provide her rating of the service and care provided by Animal Care Provider 110D, Dr. Teah. As is further described below, the provided owner rating may be used as a weighting factor in the process of matching Desired Factors 114 with Practice Factors 112 so as to identify matching Animal Care Providers 110. As is also set forth below, owner ratting is not, and need not, be the only weighting factor, or even used as a weighting factor. Indeed, an independent weighting factor may be applied during the matching process with the owner rating being mere ancillary information that an Owner 102 may consider once the matching results have been provided.

Returning to the discussion of modules for an embodiment of MACP 100, it is understood and appreciated that in varying embodiments, the elements, e.g., database module 128, the I/O module 130, and the Evaluator module 132 may be provided as software routines, hardware elements, and/or combinations thereof Although shown distinctly for ease of illustration and discussion, in varying embodiments, it is understood and appreciated that one or more of these elements may be combined and/or further subdivided into a number of sub-elements or sub-modules.

With respect to FIG. 1, the elements of the database module 128, the I/O module 130, and the Evaluator module 132 are conceptually illustrated in the context of an embodiment for a computer program 136. Such a computer program 136 may be provided upon a non-transitory computer readable media, such as an optical disc 138, or USB drive (not shown), having encoded thereto an embodiment of a program for permitting proximity based transfer of funds from one person to another.

The computer executable instructions for computer program 136 are provided to the remote server 108, i.e., computer system 124. During operation of MACP 100 the computer program 136 for matching Animal Care Providers with animal owners based on a plurality of factors with a weighting component may be maintained in active memory for enhanced speed and efficiency. In addition, the computer program 136 for matching Animal Care Providers with animal owners based on a plurality of factors with a weighting component may also be operated within a computer network and may utilize distributed resources.

Moreover, for at least one embodiment, MACP 100 may be summarized as an I/O module 130 operatively associated with an input device and a database 126, the database 126 having a plurality of records for Animal Care Providers 110 with a plurality of Practice Factors 112 including at least a name, state license, address, and animal practice for each Animal Care Provider. The I/O module 130 is further structured and arranged to receive a query from an animal Owner 102 seeking a Animal Care Provider 110. The query includes a plurality of Desired Factors. An evaluation module 132 is also provided for evaluating the query, and applies at least one weighting factor to at least one Desired Factor, the evaluation module 132 evaluating the Desired Factors to the Practice Factors 112 of each Animal Care Provider 110 in the database 126 to identify at least a subset of Animal Care Providers 110 matching on a pre-determined number of Practice Factors 112 including the weighted Desired Factor. This subset of matching Animal Care Providers 110 is provided to the I/O module 130 for delivery to the querying animal Owner 102.

Returning to FIG. 1, in varying embodiments, one or more elements of MACP 100 may be directly connected to one another, if not physically integrated with each other, but it is understood and appreciated that in most instances the incorporation of the Internet 140 and communication links 106 involving the Internet 140 as a common means of communication and information exchange is within the scope of the present invention.

It is also to be understood and appreciated that the elements of MACP 100 need not maintain continual communication links 106. In other words, Owners 102 may log on or off and thus establish a link to remote server 108, Animal Care Providers 110 may log on or off and thus establish a link to remote server 108, and the remote server 108 may be on or off line at different times for different reasons. However, in general it is understood and appreciated that for the expected operation either the elements shown or suitable substitutions are understood and appreciated to be available for expected operation of MACP 100.

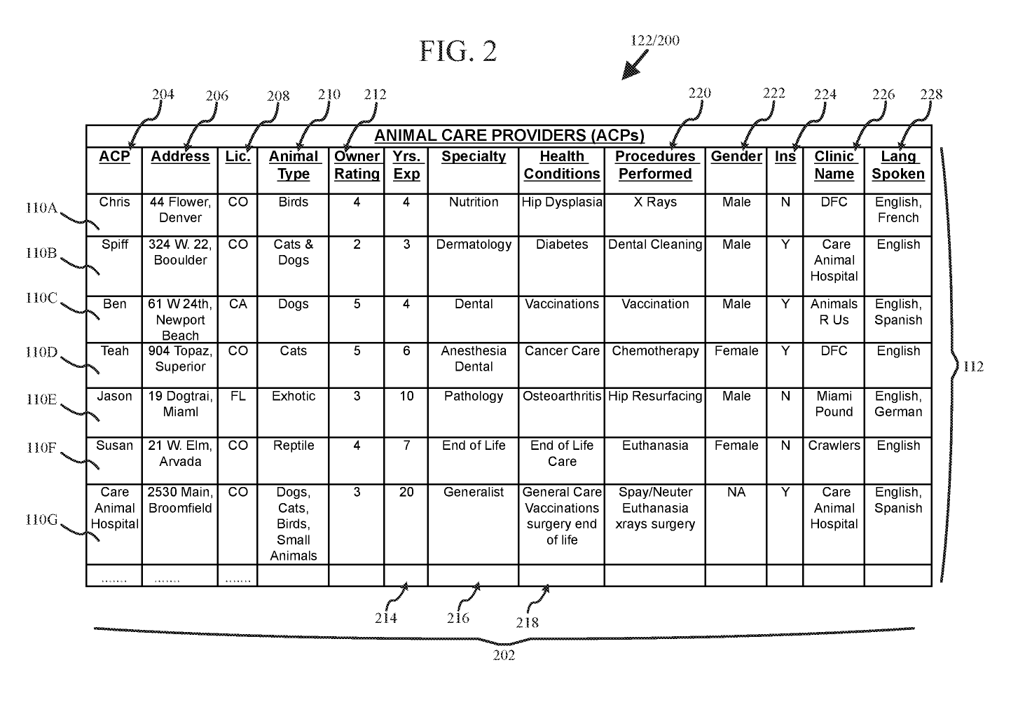

FIG. 2 provides a further example of record 118 as shown by exemplary table 200. Moreover, table 200 provides Pet Care Provider account records 202 correlating Practice Factors 112 for each Pet Care Provider 110. For the present example show, table 200 provides Practice Factors 112 shown to be Animal Care Provider—“ACP” name 204, Address 206, State License 208, Animal Type 210, Owner Rating 212, Years of Experience 214, Specialty 216, Health Conditions 218, Procedures Performed 220, Gender 222, Insurance 224, Clinic Name 226, and Language Spoken 22. Of course in varying embodiments, additional information, such as, but not strictly limited to the listing of potential Practice Factors offered above may be included, though not presently shown. Moreover, these Practice Factors 112 are mere an exemplary selection for ease of illustration and discussion.

As may also be appreciated with respect to Table 200, the records 118 permit identification of Animal Care Providers 110 as individuals as well as clinics. Indeed Animal Care Provider 110B is shown to be Spiff who is affiliated with Care Animal Hospital, which also appears as Animal Care Provider 110G.

With respect to table 200, the ability of MACP 100 to quickly and precisely match an Owners Desired Factors to actual Practice Factors is generally apparent. Specific information regarding Specialty, Health Conditions, Procedures Performed, etc . . . is readily apparent such that this information may be used to identify a subset of Animal Care Providers 110 who are potentially suitable matches for a querying Owner 102 who has provided specific Desired Factors 114 in his or her efforts to find not just any animal care provider 110, but one who the Owner believes will be a good fit for their Animal 120.

Of course in varying embodiments, MACP 100 may further incorporate traditional user account information pertaining to both Animal Owners 102 and Animal Care Providers 110, such as but not limited to user names and passwords, not shown. User names and passwords as implanted in at least one embodiment permit the Animal Care Providers to update their respective Practice Factors 112 directly. For at least one embodiment MACP 100 may be provided as a free resource to all users, with income generated from the placement of advertisements. In yet another embodiment, Animal Care Providers 110 may be required to pay a registration fee, or perhaps an additional fee for the inclusion of even more Practice Factors 112.

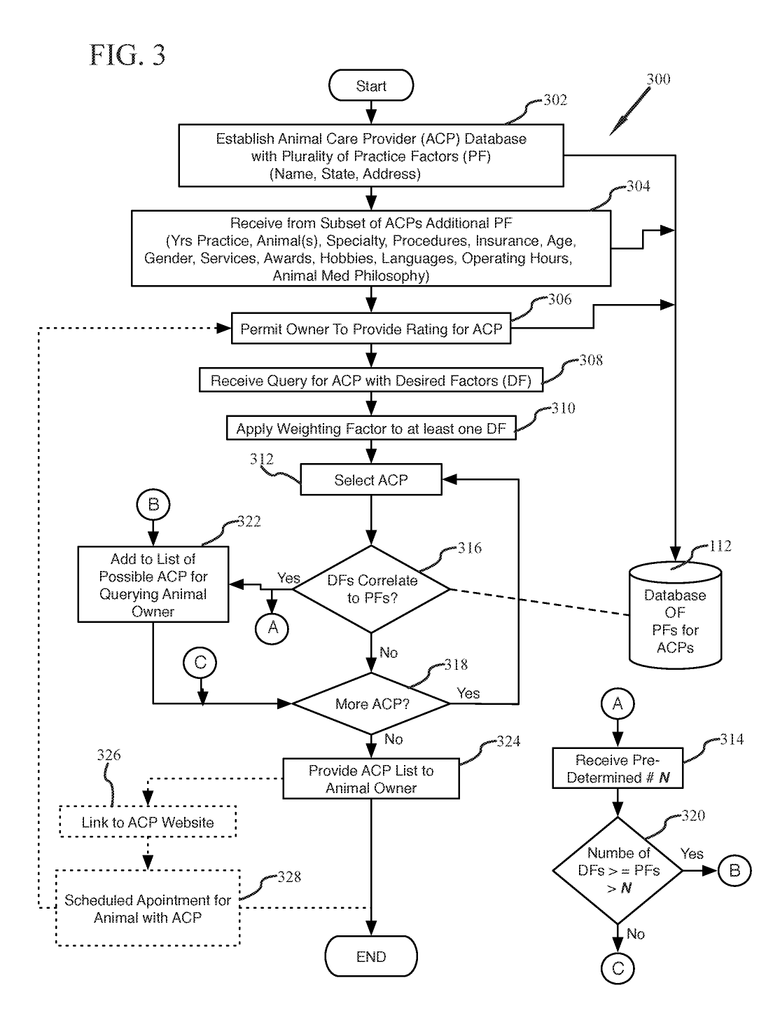

Having described embodiments for MACP 100 as shown with respect to FIG. 1 and FIG. 2, other embodiments relating to various methods of matching Animal Care Providers with Animal Owners based on a plurality of Factors with a weighting component will now be discussed with respect to exemplary method 300 shown in FIG. 3 in connection with FIGS. 1 and 2 and 4-X which further illustrate an exemplary interface as may be used by an Animal Owner 102 seeking an Animal Care Provider 110 who has a plurality of Desired Factors.

In general, method 300 commences with establishing an Animal Care Provider 110 database 122/200 having records correlating a plurality of Practice Factors for each Animal Care Provider 110 known to the MACP 100 system, block 302 (See FIGS. 1 and 2 for exemplary Database/Table). For at least one embodiment, these initial Practice Factors 112 are derived from public information available about Animal Care Providers 110, such as but not limited to Name, State License, Address, Email, Phone, etc . . .

For at least one embodiment, in addition to using this publically available information to initialize the database with Practice Factor records, this publically available information is also used to provide the identified Animal Care Providers 110 with an opportunity to provide additional Practice Factors so as to advantageously identify themselves and the specifics of their practices and specialties so as to assist querying Animal Owners to identify them.

For at least one embodiment this invitation to provide additional Practice Factors is generated as an email campaign sent to the Animal Care Providers. This email campaign may provide a hyperlink leading each Animal Care Provider back to MACP 100 with an initial user ID and Password such that the responding Animal Care Provider can provide his or her Practice Factors. In the alternative, the email campaign may provide a template within the body of the email for the Animal Care Provider to provide additional Practice Factors in the form of a reply email. Of course for yet another embodiment, the request for Additional Practice Factors could be sent by way of physical mail providing optionally a paper questionnaire, a website URL, QR Code or other linking option to enable the Animal Care Provider to respond with Additional Practice Factors.

Accordingly, method 300 continues by receiving from at least a subset of the Animal Care Providers 110 additional Practice Factors, block 304. For at least one embodiment these additional Practice Factors as noted above and which may include, but are not strictly limited to, years in practice, Animal(s), Specialties, Procedures, Insurance, Age, Gender, Services, Awards, Hobbies, Languages, etc . . . Once again, Practice Factors 112 are recorded to the database 126.

It is also an advantageous aspect of MACP 100 that Animal Owners 102 are permitted to provide feedback in the form of Owner Ratings for their experiences in working with the Animal Care Providers 110. Accordingly method 300 permits Owners to provide a rating for an Animal Care Provider 110 that has provided care to the Owner's Animal, block 306. Of course, the Owner cannot provide this rating until he or she has had some involvement with the Animal Care Provider 110.

As such, and for the purposes of example, it will be assumed that MACP 100 exists with a database 126 providing records of Practice Factors 112 for a plurality of Animal Care Providers 110, and this description will now proceed to discuss how an Animal Owner 102 is matched to an Animal Care Provider 110 based on a submitted query specifying a plurality of Desired Factors.

For this example, Owner 102A, Jill has a ragdoll cat named Olaf. As she is new to the Denver area, she is looking for an Animal Care Provider 110 to care for Olaf She is motivated to find an Animal Care Provider 110 who is familiar with Ragdoll cats, accepts insurance, is familiar with cancer care, offers dental services and who is female. These factors are more important to her then just how close the Animal Care Provider may be to where she now lives.

Jill directs her First User Device 104 to MACP 100, which is to say that for at least one embodiment, she directs her web browser to the URL for MACP 100. FIG. 4 provides a conceptual rendering 400 of an initial set of fields she is presented with, a set of active buttons that permit her to specify Animal Type 402, Vet Specialty 404, Distance 406, Procedures Performed 408, Health Condition 410, Other 412, View Recommendations 414, and Home 416. Of course varying embodiments may provide alternative active buttons or links, as well as directed advertising.

Initially, Jill, selects Animal Type 402, and is presented with a drop down listing of animal type which may be an alphabetical listing. As shown in FIG. 5, Jill selects Cat 500, and then provides her pet's breed—Ragdoll. This is her first specified Desired Factor.

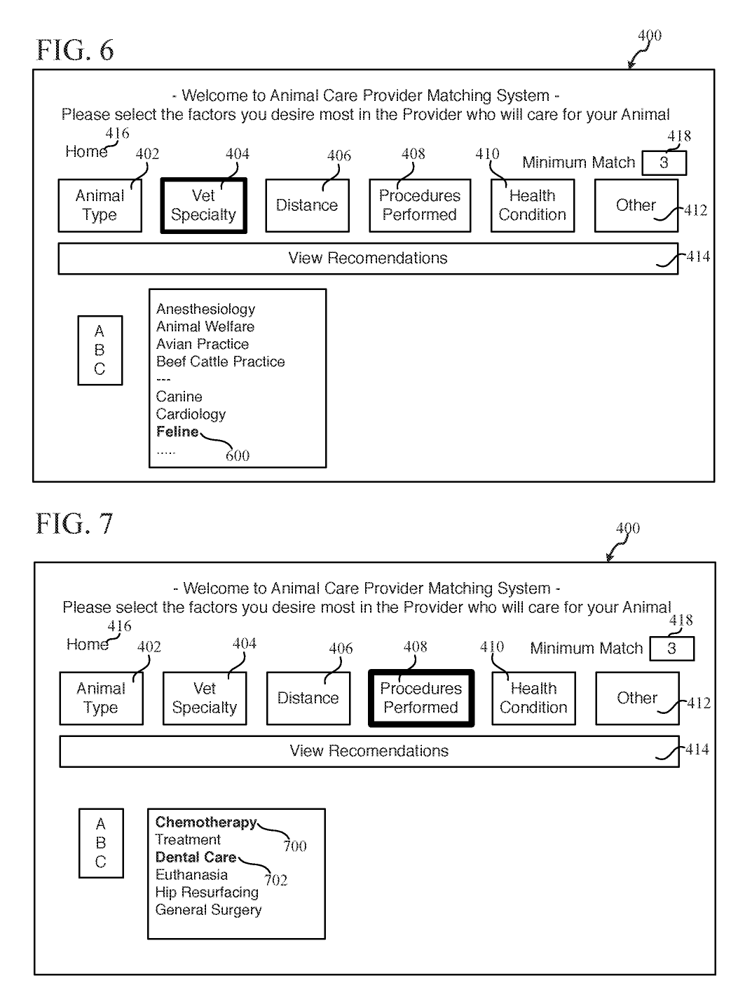

In FIG. 6, Jill then selects Vet Specialty 404, and is presented with a similar drop down listing where she can select the desired specialty, in this case Feline care, 600. This is her second specified Desired Factor. As distance it not a significant factor for Jill, she may bypass the Distance option 406, and select Procedures Performed 408, which again presents her with a drop down listing of possible procedures in alphabetic listing as shown in FIG. 6. Here she can navigate to select Chemotherapy 700 and Dental Care 702, as her third and fourth specified Desired Factors.

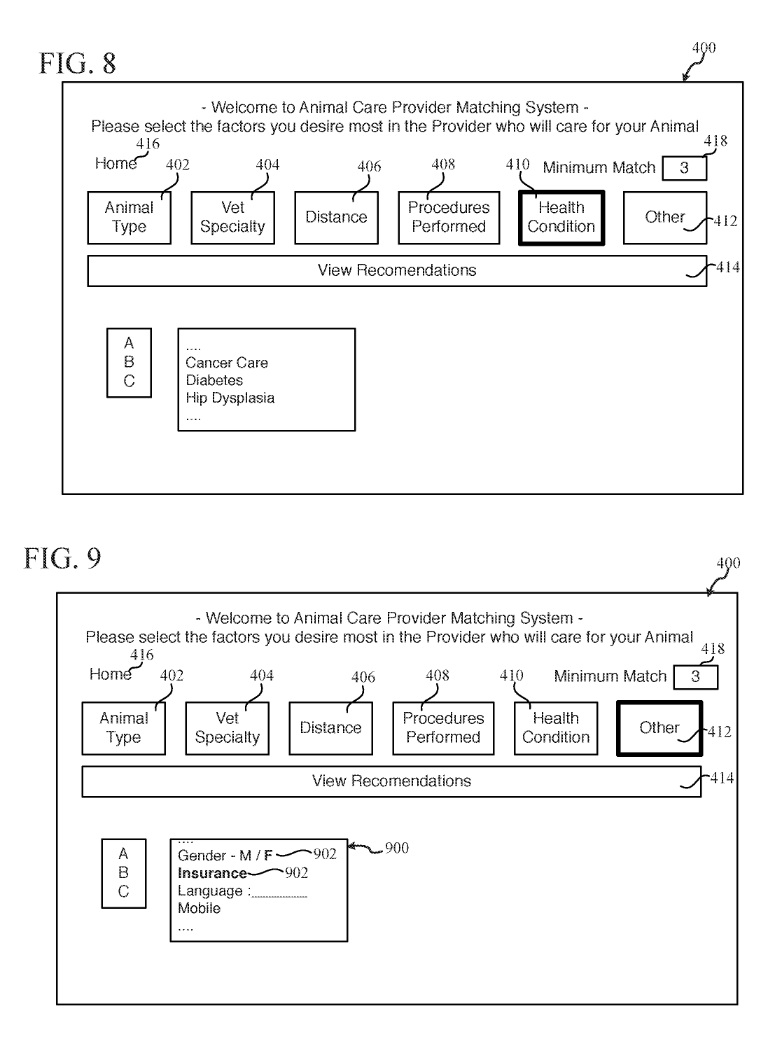

As shown in FIG. 8 Jill continues by selecting Health Condition 410 to see options there, but makes no selection. In FIG. 9 she selects Other 412 and is once again presented with a dropdown listing of Other Factors 900, and in this case selects Gender F 902 and Insurance 904.

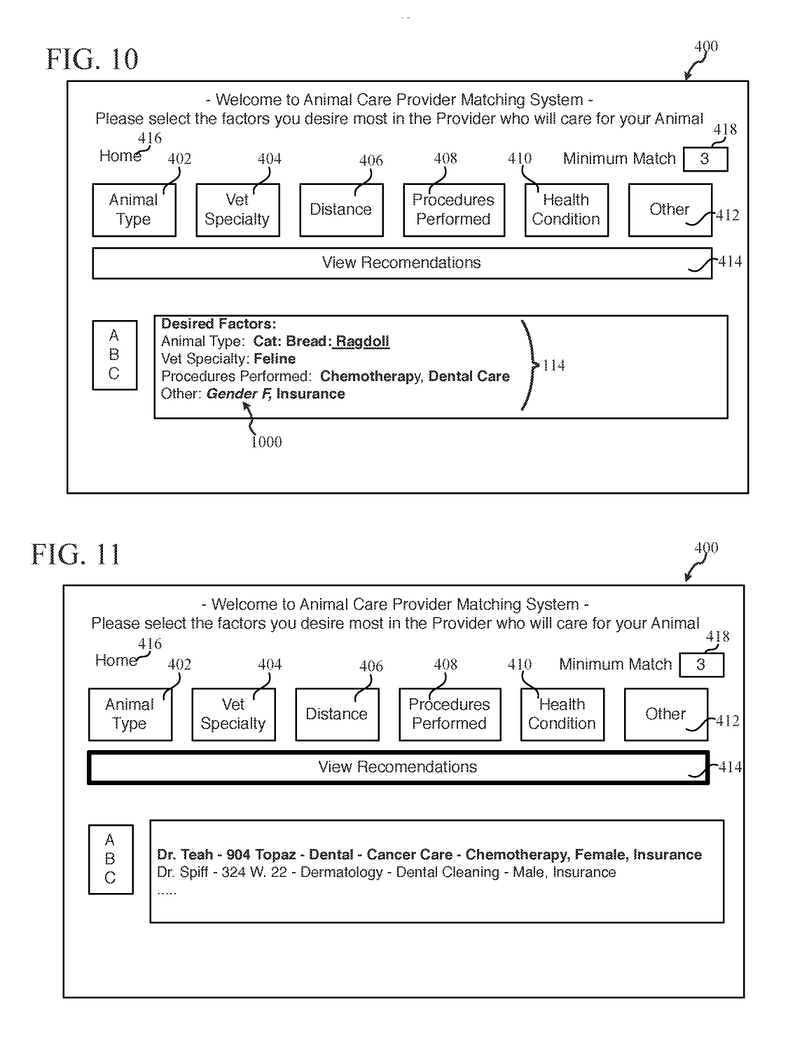

Selecting the Home Option 416, as shown in FIG. 10, Jill has now is shown the specified seven Desired Factors 114 that she would like to find in an Animal Care Provider 110 for Olaf, her Animal 120. Jill is also permitted to specify the most important Desired Factor, which for the present example is the Desired Factor to be weighted 1000. In optional embodiments she may be permitted to indicate a hierarchy of Desired Factors 114. In this case, it is the gender of the practitioner to be female, which Jill has selected as the important Desired Factor to be weighted 1000, has been shown in italics.

Returning to FIG. 3, MACP 100 receives the query of Desired Factors from Jill, which is in essence the specified Desired Factors shown in FIG. 10, block 308. Method 300 now continues by applying a weighting factor to at least one Desired Factor, block 310.

The nature of the weighting factor is significantly advantageous to MACP 100 and method 300. In the present example, Jill has specified Gender as the most important Desired Factor. As such method 300 notes that correlating the Desired Factor of Gender to a Pet Care Providers Practice Factor of Gender is an issue of significant importance for this particular Owner.

For at least one embodiment, the correlation of Desired Factors to Practice Factors may be performed on a point system. Moreover, if there is a correlation between a specified Desired Factor and a Practice Factor then the Animal Care Provider will receive 1 point for the match, whereas if there is no correlation then there is no point awarded. For at least one embodiment the Weighting factor applied to the preferred Desired Factor is a multiplier so as to increase the accumulated point value realized when a preferred Desired Factor correlates with a Practice Factor.

With respect to the present example, Jill has specified seven Desired Factors (she has specified Animal type as Feline, but also Olaf's breed as Ragdoll). For the present example, method 300 will compare these Desired Factors to the database of Practice Factors associated with Animal Care Providers 110 so as to identify at least a subset of Animal Care Providers who meet at least a pre-determined number of the Desired Factors. The ranking of the subset of matching Animal Care Providers is determined by aggregate point total. For the sake of example, the assignment of points for the Desired Factors is as follows:
Animal Type: Cat: Breed Ragdoll; (1/1)
Vet Specialty: Feline; (1)
Procedures Performed: Chemotherapy, Dental (1/1)
Other: Gender F, Insurance (1+W/1)
[W=1/3 Count of Desired Factors=2.1]

Moreover it is appreciated that the Weighting Factor W increases the point total of this Desired Factor, but it is not the sole deciding factor. For the present example, for an Animal Care Provider 110 to be returned as a possible match, they must match on at least three Desired Factors. Method 300 is therefore provide with an initial pre-determined match requirement of 3 factors, block 314.

For at least one embodiment, the querying Animal Owner may specify the number of Factors that must be matched. For yet another embodiment, the number of Factors that must be matched is preset. For still yet another embodiment, the number of factors that must be matched is a percentage of the number of Desired Factors specified. Of course, for alternative embodiments, no pre-determined match threshold may be required and all results will simply be returned ranked from highest to lowest.

Method 300 now performs the evaluation by selecting an Animal Care Provider 110, block 312. With respect to FIG. 2, the first ACP is Chris 110A. Chris is selected and method 300 operates to determine if there is a correlation between Jill's Desired Factors and Chris's Practice Factors, decision 316. In this case there is no correlation between Jill's Desired Factors and Chris's Practice Factors so his evaluation is 0. As there are more ACPs, decision 318, method 300 continued to select the next ACP, in this case Spiff 110B.

In this case, the database records shown in table 200 of FIG. 2 indicate that Spiff works with Dogs and Cats, so there is a match for Animal Type at the general level—Cat (1 point). Spiff also provides Dental Cleaning (1 point), and accepts insurance (1 point). Moreover, Spiff has three Practice Factors that correlate to Jill's Desired Factors. As Spiff has met the threshold number of matching Factors, decision 320, he is added to the list of possible ACPs for Jill, block 322.

Method 300 continues as there are more ACPs for evaluation, and eventually selects ACP Teah 110D, block 312. In this case, the database records shown in table 200 of FIG. 2, indicate that Teah works with Cats, so again there is a match for Animal Type at the general level—Cat (1 point). Teah also specializes in Dental treatment (1 point), performs Chemotherapy (1 point), accepts Insurance (1 point), and is Female (1×2.1). Teah has matched on more than the minimum number of matching points, decision 320, and is therefore added to the list of possible ACPs, block 322. Based on the simple point accumulation system set forth above, her point total is 6.1.

In varying embodiments, method 300 may continue this evaluation of known ACPs 110 until all have been evaluated, or until at least a sufficient number of matches have been determined. For the present example it is assumed that all ACPs 110 have been evaluated such that no more remain for evaluation, decision 318.

Method 300 now provides the determined matching ACP list to the querying animal Owner 102, block 324. This displayed list is shown in FIG. 11. As Teah's total point score is 6.1 she is now the most highly ranked, and is reported above ACP Spiff 102B to Owner Jill, as is shown in FIG. 11.

Jill may then be optionally permitted to select ACP Teah 110D and visit her website, optional block 326, and potentially schedule an appointment for Olaf, optional block 328.

Following Olaf's appointment with ACP Teah 102D, Jill may return to MACP 100 and provide a rating for ACP Teah 102D, block 306. Of course, this rating provided by Owner Jill, is a Practice Factor associated with ACP Teah 102D.

Moreover, the developed Rating may also serve as a Weighting Factor. For example, if the querying Owner opts not to specify at least one Desired Factor as being of greater importance, MACP 100 and/or method 300 may apply the Rating to the accumulated point total for each ACP. As such, MACP 100 and/or method 300 are advantageously enabled to help indicate a possible ordered preference of ACPs 110 who otherwise are generally equal in point total based on how other Animal Owners have rated them.

Indeed, for at least one embodiment, a Weighting Factor based on Owner Rating may be applied in addition to the Weighting Factor applied to the Desired Factor indicated as being preferred by the querying Owner.

As noted above, an Animal Care Provider may be an individual or an entity such as a clinic or hospital. In the present example, table 200 of FIG. 2, indicates that Spiff is affiliated with the “Care Animal Hospital”. As such, for at least one embodiment his point total may be inherited by ACP 110H due to his affiliation. The higher Rating indicated for Care Animal Hospital may be due to a number of factors such as more support staff, larger kennels, better food, etc . . . Further still, as Care Animal Hospital has a higher Owner Rating (3) then does Spiff (2), the Practice Factor of Owner Rating may be applied to rank Care Animal Hospital as a possible matching Animal Care Provider above Spiff alone.

It is of course understood and appreciated that the simplistic point total system set forth above is presented for ease of illustration and discussion. In varying embodiments, different Practice Factors may be accorded different values, such as a first value for a general level—Cat, and a percentage value for a breed (Ragdoll=0.5). In addition some Practice Factors, may be awarded a lesser point value then other Practice Factors—i.e., Cardiologist=2 points, Hobbies include marathon running=0.25.

For yet another embodiment, the order in which the Desired Factors are selected by the querying owner, or re-ordered at the time of submitting the query may be used to specify a relative weighting factor for accounting points as between matching Desired Factors and Practice Factors. For example, if a querying Owner submits a query specifying ten Desired Factors with “Hobbies Include marathon Running” being first and “Cardiology” being last, an ACP 110 who matches on the Practice Factor of being a Marathon Runner may be given a higher score for this particular Desired Factor then is awarded on for the Practice Field of being an animal Cardiologist.

Moreover, in light of the above description and narrative examples, it should be understood and appreciated that MACP 100 and method 300 are advantageously permitting Animal Owners to identify Animal Care Practitioners on a plurality of different Factors. Certainly distance between the Owner and the ACP may be a factor, but a query and resulting match may be determined based on a plurality of Desired Factors evaluated to Practice Factors that are entirely separate from the issue of proximity.

Of greater significance is the advantageous nature of MACP 100 and method 300 to permit Animal Care Providers to market themselves and their services to a greater population of Animal Owners without having to structure the marketing effort. More specifically, each Animal Care Provider is provided with the opportunity to provide Practice Factors that serve to further define and differentiate themselves from one another. How these specified Practice Factors correlate to the Desired Factors specified by an Animal Owner are the advantageous key.

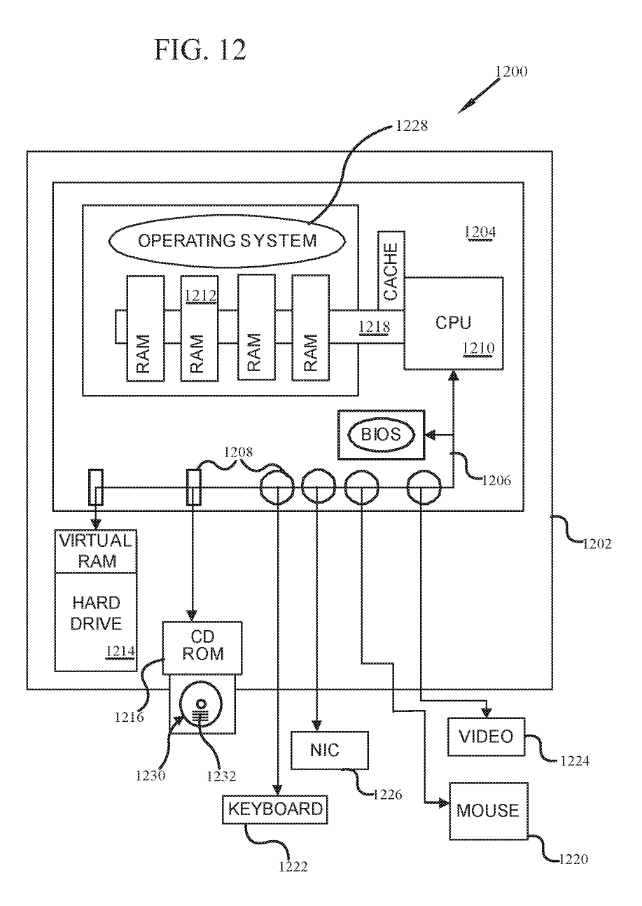

With respect to the above description of the systems and methods involving matching Animal Care Providers 110 with animal owners 102, it is understood and appreciated that the method may be rendered in a variety of different forms of code and instruction as may be used for different computer systems and environments. To expand upon the initial suggestion of the Owners 102 First Devices 104, ACPs 110 Second Devices 118, and the remote server system 108 being computer systems adapted to their specific roles, FIG. 12 is a high level block diagram of an exemplary computer system 1200 such as may be provided for one or more of the elements comprising a First Device 104, Second Device 118, and the remote server 108 whether provided as distinct individual systems or integrated together in one or more computer systems.

Computer system 1200 has a case 1202, enclosing a main board 1204. The main board 1204 has a system bus 1206, connection ports 1208, a processing unit, such as Central Processing Unit (CPU) 1210 with at least one microprocessor (not shown) and a memory storage device, such as main memory 1212, hard drive 1214 and CD/DVD ROM drive 1216.

Memory bus 1218 couples main memory 1212 to the CPU 1210. A system bus 1206 couples the hard disc drive 1214, CD/DVD ROM drive 1216 and connection ports 128 to the CPU 1210. Multiple input devices may be provided, such as, for example, a mouse 1220 and keyboard 1222. Multiple output devices may also be provided, such as, for example, a video monitor 1224 and a printer (not shown). As computer system 1200 is intended to be interconnected with other computer systems in the MACP 100 a combined input/output device such as at least one network interface card, or NIC 1226 is also provided.

Computer system 1200 may be a commercially available system, such as a desktop workstation unit provided by IBM, Dell Computers, Gateway, Apple, or other computer system provider. Computer system 1200 may also be a networked computer system, wherein memory storage components such as hard drive 1214, additional CPUs 1210 and output devices such as printers are provided by physically separate computer systems commonly connected together in the network.

Those skilled in the art will understand and appreciate that the physical composition of components and component interconnections are comprised by the computer system 1200 are indeed variable and select a computer system suitable for one or more of the computer systems incorporated in the formation and operation of MACP 100.

When computer system 1200 is activated, preferably an operating system 1228 will load into main memory 1212 as part of the boot strap startup sequence and ready the computer system 1200 for operation. At the simplest level, and in the most general sense, the tasks of an operating system fall into specific categories, such as, process management, device management (including application and user interface management) and memory management, for example. The form of the computer-readable medium 1230 and language of the program 1232 are understood to be appropriate for and functionally cooperate with the computer system 1200.

Moreover, variations of computer system 1200 may be adapted to provide the physical elements of one or more components comprising each First Device 104, Second Device 118, the remote server 108, and the switches, routers and such other components as may be desired and appropriate for the systems and methods involving matching Animal Care Providers 110 with Animal Owners 102.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed is:

1. A method of matching Animal Care Providers with animal owners based on a plurality of factors with a weighting component, comprising:
establishing a database record of Animal Care Providers from public information specifying for each Animal Care Provider a plurality of Practice Factors including at least a name, state license, address, and animal practice;
receiving from at least a subset of Animal Care Providers additional Practice Factors correlated to the providing Animal Care Provider, the additional Practice Factors selected from a group consisting of: years in practice, animal specialty, procedure specialty, veterinarian age, veterinarian gender, animal type, category of services offered, insurance accepted;
receiving a query from a animal owner seeking an Animal Care Provider, the query including a plurality of Desired Factors;
applying at least one weighting factor to at least one Desired Factor and evaluating the Desired Factors to the Practice Factors of each Animal Care Provider in the database record to identify at least a subset of Animal Care Providers matching at least a pre-determined number of factors including the weighted Desired Factor; and
returning to the querying animal owner the subset of matching Animal Care Providers.

2. The method of claim 1, wherein the Animal Care Provider is a veterinarian or animal care giver.

3. The method of claim 1, wherein the Animal Care Provider is an animal clinic having at least one veterinarian.

4. The method of claim 1, further permitting at least one animal owner to provide a rating as an additional Practice Factor of at least one Animal Care Provider recorded in the database record.

5. The method of claim 1, wherein the Desired Factor receiving applied weighting factor is specified by the querying animal owner.

6. The method of claim 1, wherein the Desired Factor receiving applied weighting factor is determined by a party other than the querying animal owner.

7. The method of claim 1, wherein the querying animal owner is permitted to order the Desired Factors in order of importance for matching to the Practice Factors.

8. The method of claim 1, wherein the pre-determined number of factors to match is specified by the querying animal owner.

9. The method of claim 1, wherein the pre-determined number of factors to match is specified by the querying animal owner.

10. The method of claim 1, wherein the additional Practice Factors further include factors selected from a group consisting of: animal medical philosophy, awards, honors, professional memberships, languages, hobbies, clinic affiliations, operating hours.

11. The method of claim 1, wherein the query from the animal owner further includes distance from the animal owner as a Desired Factor.

12. The method of claim 11, wherein the distance from the animal owner is not the Desired Factor to which the weighting factor is applied.

13. The method of claim 1, wherein the method is provided on a non-transitory machine readable medium as a computer program comprising instructions which when executed by a computer system having at least one processor performs the steps of correlating Animal Care Providers with animal owners based on a plurality of factors.

14. A method of matching Animal Care Providers with animal owners based on a plurality of factors with a weighting component, comprising:
a database system having a processor and a database, the database having a plurality of records for Animal Care Providers with a plurality of Practice Factors including at least a name, state license, address, and animal practice for each Animal Care Provider;
an I/O system having at least one processor and being in communication with the database system, the I/O system structured and arranged to receive from at least a subset of Animal Care Providers additional Practice Factors selected from a group consisting of: years in practice, animal specialty, procedure specialty, veterinarian age, veterinarian gender, animal type, category of services offered, insurance accepted; the I/O system further structured and arranged to receive a query from a animal owner seeking a Animal Care Provider, the query including a plurality of Desired Factors; and
an evaluation system having at least one processor and being in communication with the database system and the I/O system, the evaluation system structured and arranged to receive the query from the I/O system and apply at least one weighting factor to at least one Desired Factor, the evaluation system evaluating the Desired Factors to the Practice Factors of each Animal Care Provider in the database to identify at least a subset of Animal Care Providers matching a pre-determined number of factors including the weighted Desired Factor, and returning the subset of matching Animal Care Providers to the I/O system for delivery to the querying animal owner.

15. The system of claim 14, wherein the I/O system is a component of the database system.

16. The system of claim 14, wherein the I/O system is a component of the evaluation system.

17. The system of claim 14, wherein the evaluation system is a component of the database system.

18. The system of claim 14, wherein the Animal Care Provider is a veterinarian or animal care giver.

19. The system of claim 14, wherein the Animal Care Provider is an animal clinic having at least one veterinarian.

20. The system of claim 14, wherein the I/O system further permits at least one animal owner to provide a rating as an additional Practice Factor of at least one Animal Care Provider recorded in the database.

21. The system of claim 14, wherein the Desired Factor receiving applied weighting factor is specified by the querying animal owner.

22. The system of claim 14, wherein the Desired Factor receiving applied weighting factor is determined by a party other than the querying animal owner.

23. The system of claim 14, wherein the querying animal owner is permitted to order the Desired Factors in order of importance for matching to the Practice Factors.

24. The system of claim 14, wherein the pre-determined number of factors to match is specified by the querying animal owner.

25. The system of claim 14, wherein the pre-determined number of factors to match is specified by a party other than the querying animal owner.

26. The system of claim 14, wherein the additional Practice Factors further include factors selected from a group consisting of: animal medical philosophy, awards, honors, professional memberships, languages, hobbies, clinic affiliations, operating hours.

27. The system of claim 14, wherein the query from the animal owner further includes distance from the animal owner as a Desired Factor.

28. A non-transitory machine readable medium on which is stored a computer program comprising instructions to adapt a computer system having at least one processor to match Animal Care Providers with animal owners based on a plurality of factors with a weighting component, comprising:
an I/O module operatively associated with an input device and a database, the database having a plurality of records for Animal Care Providers with a plurality of Practice Factors including at least a name, state license, address, and animal practice for each Animal Care Provider, the I/O module further structured and arranged to receive a query from an animal owner seeking a Animal Care Provider, the query including a plurality of Desired Factors; and
an evaluation module for evaluating the query and applying at least one weighting factor to at least one Desired Factor, the evaluation module evaluating the Desired Factors to the Practice Factors of each Animal Care Provider in the database to identify at least a subset of Animal Care Providers matching a pre-determined number of Practice Factors including the weighted Desired Factor, and returning the subset of matching Animal Care Providers to the I/O module for delivery to the querying animal owner.

29. The non-transitory machine readable medium of claim 28, wherein the receiver module further permits receipt from at least a subset of Animal Care Providers additional Practice Factors selected from a group consisting of: years in practice, animal specialty, procedure specialty, veterinarian age, veterinarian gender, animal type, category of services offered, insurance accepted.

30. The non-transitory machine readable medium of claim 28, wherein the Animal Care Provider is a veterinarian or animal care giver.

31. The non-transitory machine readable medium of claim 28, wherein the Animal Care Provider is a animal clinic having at least one veterinarian.

32. The non-transitory machine readable medium of claim 28, wherein the receiver module further permits at least one animal owner to provide a rating as an additional Practice Factor of at least one Animal Care Provider recorded in the database.

33. The non-transitory machine readable medium of claim 28, wherein the Desired Factor receiving applied weighting factor is specified by the querying animal owner.

34. The non-transitory machine readable medium of claim 28, wherein the Desired Factor receiving applied weighting factor is determined by a party other than the querying animal owner.

35. The non-transitory machine readable medium of claim 28, wherein the querying animal owner is permitted to order the Desired Factors in order of importance for matching to the Practice Factors.

36. The non-transitory machine readable medium of claim 28, wherein the pre-determined number of factors to match is specified by the querying animal owner.

37. The non-transitory machine readable medium of claim 28, wherein the pre-determined number of factors to match is specified by a party other than the querying animal owner.

38. The non-transitory machine readable medium of claim 28, wherein the additional Practice Factors further include factors selected from a group consisting of: animal medical philosophy, awards, honors, professional memberships, languages, hobbies, clinic affiliations, operating hours.

39. The non-transitory machine readable medium of claim 28, wherein the query from the animal owner further includes distance from the animal owner as a Desired Factor.
